(19) United States
(12) Patent Application Publication
(10) Pub. No.: US 2022/0095612 A1
(43) Pub. Date: Mar. 31, 2022

(54) MICRONUTRIENT COMPOSITIONS AND SYSTEMS AND METHODS OF USING SAME

(71) Applicant: Nanochem Solutions, Inc., Bedford Park, IL (US)

(72) Inventor: George Murray, Lebanon, IN (US)

(21) Appl. No.: 17/490,885

(22) Filed: Sep. 30, 2021

Related U.S. Application Data
(60) Provisional application No. 63/085,576, filed on Sep. 30, 2020.

(51) Int. Cl. A01N 25/22; A01N 25/04; A01N 57/20; A01P 13/00

(52) U.S. Cl. CPC A01N 25/22; A01P 13/00; A01N 57/20; A01N 25/04

(57) ABSTRACT

An agricultural spray solution may be produced by admixing chelated metal diaspartate salts reacted with ethanolamine that can also be mixed with a carboxylated polymer salt and a pesticide or other agricultural chemical containing components capable of precipitating with the unchelated metal in the admixture. The composition may be produced by reacting L-aspartic acid with metal oxides at a molar ratio of 2:1, subsequently reacting the finished diaspartate salt with ethanolamine can increase the solubility and depress the freezing point, and then taking that metal diaspartate chelate and admixing it with a carboxylated polymer salt, which can then be admixed with a pesticide. The diaspartate chelation of the metal and carboxylated polymer salt can protect the metal from adverse interactions with a pesticide or other chemical additive.

### CROSS-REFERENCE TO RELATED APPLICATION

This U.S. Patent Application Patent Application claims priority to U.S. Provisional Application: 63/085,576 filed Sep. 30, 2020, the disclosure of which is considered part of the disclosure of this application and is hereby incorporated by reference in its entirety.

### FIELD OF THE INVENTION

The present disclosure relates to products, systems, and methods for using compositions improving the stability and compatibility of agricultural products, and more particularly, for improving the stability the compatibility of micronutrients in agricultural mixes.

### BACKGROUND

Pesticides are an important part of agricultural. They are used to suppress weeds, insects, mites, bacterial, and fungal organisms that may otherwise decrease the yields of the crops or eliminate any yields altogether. Spraying the pesticides is an expensive proposition—not only in terms of the actual material, but also in the cost of operating and using the equipment necessary to spray the pesticides.

In addition to pesticides, micronutrients can have a profound impact on crop yields. Whether chronic (due to deficiencies in the soil), or transient (brought on by a particularly high demand for a specific micronutrient or micronutrients during a specific period in the crops growth; or, alternatively, brought on by the application of a pesticide itself, such as glyphosate), foliar applications of specific micronutrients at specific periods of the crop's growth can improve yields. Various micronutrient components can provide various advantageous roles to foliage and plants. Boron provides structural linkages within cell walls; chlorine acts as an osmoticum like potassium; copper plays important roles in protecting chloroplasts, and producing ATP; iron is required for metabolic functions related to respiration, DNA synthesis, photosynthesis, and nitrogen fixation; manganese assists in photosynthesis, and plant defense; molybdenum plans an important role in nitrate metabolism in plants; nickel plays a role in urea metabolism; and zinc is responsible for a plethora of processes in plants relating to RNA production, hormone production, plant defense, and chlorophyll production.

With the expense of applying a pesticide, and the need to address chronic and/or transient nutrient deficiencies in crops, it would be optimal to spray both a pesticide and a micronutrient at the same time or in an all-in-one application. Unfortunately, the charges of the different materials can interact in the spray tank, resulting in precipitates that have diminished efficacy of both the pesticide as well as the micronutrients components. The precipitates can further result in clogging spraying nozzles and damaging equipment. In order to prevent these precipitates, micronutrients can be chelated by pentadentate and hexadentate ligands like iminodisuccunic acid (IDS) and its salts as well as ethylenediaminetetraacetic acid (EDTA) and its salts, as well as other synthetic man-made chelates such as diethylenetriaminepentaacetic acid (DTPA) and its salts, and ethylenediamine-N,N′-bis(2-hydroxyphenylacetic acid) EDDHA and its salts.

While these above components are well known chelating molecules that form high stability constants with metal micronutrients, they are also xenobiotic (foreign) substances to plants and are known to cause phytotoxicity as the plants have very few ways to metabolize the structures and make any use of them. As such, there exists a need to create chelate that can form reasonably high stability constants, at least high enough to protect the metal from interactions from other molecules in solution but can also be usable to the plant. There also exists a need for these chelates to enhance the mobility of the metal in the plant since when sprayed foliarly, the primary movement of the metal-chelate structure will be through the phloem in the vascular system (as the metal moves from the source to the sink in the plant).

### BRIEF SUMMARY OF THE INVENTION

In one aspect of the present disclosure, some exemplary embodiments provide micronutrient compositions for use with agricultural chemicals and/or additives containing components normally capable of precipitating with micronutrients (usually found in the form of metal salts that have vary degrees of water solubility), and approaches for using these compositions to and compositions to limit or prevent precipitation of the metal salt components.

In yet another aspect, the present disclosure provides an exemplary method of spraying an agricultural spray involves admixing a micronutrient composition comprising diaspartate metal salt chelates and a carboxylated polymer salt and an additional additive such as a pesticide or other chemical additive. In some exemplary embodiments, the pesticide can be a phosphate, wherein the phosphate can be configured to prevent the metal from forming an insoluble precipitate with the phosphate.

In some exemplary embodiments, a L-aspartic acid and metal salts may be present in a ratio of about 4:1 to about 1:4, allowing them to form diaspartate metal salt chelates. In one exemplary embodiment, the ration can be 2:1 L-aspartic acid to metal salt. The metal salt can be a metal salt of one or more, including, but not limited to, calcium, magnesium, boron, cobalt, copper, iron, manganese, molybdenum, nickel, and zinc. An admixed carboxylated polymer salt can be added as an additional layer of protection for the metals in a spray solution with pesticides that contain atoms and molecules that could negatively interact with the metal and form an insoluble precipitate in the spray tank.

In yet another aspect, the disclosure relates to a composition that can include a diaspartate metal salt chelate that can be reacted with a base addition, including but not limited to ethanolamine which can increase the pH of the solution, to increase the solubility of the molecule by increasing the overall charge of the diaspartate metal salt chelate, and thereby depressing the freezing point of the solution. In some exemplary embodiments, the composition can consist of an admix of aspartic acid and ethanolamine (1:1 ratio with aspartic acid) with a metal oxide and a carboxylated polymer salt and a pesticide. In some exemplary embodiments, the pesticide can include phosphate. The composition can allow the aspartic acid to chelate a metal oxide and along with the carboxylated polymer salt, thereby preventing the metal oxide from forming an insoluble solid with the phosphate. Aspartic acid can be present in a molar ratio of 2:1. The admixture composition can remain stable and non-precipitated when mixed with a herbicide or pesticide in a storage vessel containing an aqueous solution, including but not limited to water, for between about 24 hours to about 1 year or about 48 hours to 6 months, or for at least 72 hours. The admixture with or without an additional additive such as a herbicide or pesticide composition can then be sprayed on an environment, such as the ground or the foliar surface of a plant. Additionally, the combined micronutrient and additive solution can further be diluted with water. The combined aqueous solution can then be applied to an environment, which may include a ground surface, foliar surface, or crop.

In some exemplary embodiments, diaspartate metal chelates can be mixed with a carboxylated polymer salt and may be used to produce an exemplary agricultural spray by mixing the diaspartate metal chelates with ethanolamine and carboxylated polymer salt with a pesticide or a fertilizer. Such pesticides may include one or more of the following: N-(phosphonomethyl)glycine, 4-Dichlorophenoxyacetic acid, bentazon, 3,5-dichloro-o-anisic acid, 3,6-dichloro-2-methoxybenzoic acid, 1-chloro-3-ethylamino-5-isopropylaminoe-2,4,6-triazine, amide herbicides, arsenical herbicides, carbamate and thiocarbamate herbicides, carboxylic acid herbicides, dinitroaniline herbicides, heterocyclic nitrogen-containing herbicides, organophosphate compounds, urea herbicides, and quaternary herbicides, 5-[2-chloro-4-(trifluoromethyl)phenoxy]-N-(methylsulfonyl)-2-nitrobenzamide, tembotrione or a salt of an ester of the pesticide.

In yet another aspect, the present disclosure relates to a composition for enhancing micronutrient uptake in a plant, wherein the composition includes at least on metal salt, an aspartic acid, and a carboxylate polymer. The composition can further include a pesticide.

In yet another aspect, the present disclosure relates to a solution for treating an environment comprising a micronutrient composition. The micronutrient composition can include a metal salt component comprising between 4-12% by weight of the micronutrient composition, an amino acid component comprising between 18-44% by weight of the micronutrient composition wherein the amino acid component is combined with ethanolamine at a 1:1 ratio, wherein the amino acid component is present in a molar ratio of 2:1 with respect to the metal salt component, and a carboxylated polymer component comprising between 2.5-15% by weight of the micronutrient composition, wherein the amino acid component chelates the metal salt component and along with the carboxylated polymer component prevents the metal salt component from forming an insoluble solid. The solution can further include an additional addictive including but not limited to a herbicide, pesticide, fungicide, or other additive. In some embodiments, a pesticide and micronutrient composition can remain stable in the solution for a duration of time without precipitation.

In yet another aspect, the micronutrient composition including an amino acid component, metal salt component, and carboxylated polymer component can be added in a vessel containing water with a chemical additive component. The chemical additive component can be pesticides, herbicides, insecticides, acaricides, bactericides, and/or fungicides. The micronutrient composition and can be added and/or diluted in a water solution in a vessel in a ration between about 4:1 and 1:4.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a photograph of a finished manganese diaspartate solution (6.0% manganese by weight) with potassium polyaspartate (5.0% by weight).

FIG. 2 is a photograph of a finished zinc diaspartate solution (8.0% zinc by weight) with potassium polyaspartate (5.0% by weight).

FIG. 3 is a photograph of a micronutrient diaspartate mixture containing boron (0.5% by weight), manganese (2.0% by weight), molybdenum (0.05% by weight), zinc (2.0% by weight), and potassium polyaspartate (5.0% by weight).

FIG. 4 is a photograph of the micronutrient mixture from FIG. 3 mixed with glyphosate (Roundup PowerMAX, Bayer Crop Sciences) after 14 days at an equivalent rate of 64 ounces of each product in 10 gallons of water.

FIG. 5 is a photograph of the micronutrient mixture from FIG. 3 mixed with dicamba (Vision, Helena Chemical Company) after 14 days at an equivalent rate of 64 ounces of each product in 10 gallons of water.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

In some exemplary embodiments, the present disclosure can provide a micronutrient composition having an amino acid to metal salt ratio wherein the amount of amino acid is higher than that of the metal salt present. In some embodiments, the amino acid to metal salt ration can be between about 3:1 or about 2:1 so as each amino acid can chelate the metal ion of the micronutrient. In one exemplary embodiment, the micronutrient composition can include L-aspartic acid at a 2:1 ratio to the metal salt. An L-aspartic acid can include two carboxyl groups, wherein an alpha carboxyl can deprotonate at a pH of about 2.09, and the carboxyl side group can deprotonate at about 3.86. In addition to this, L-aspartic acid can have one amine (NH₂) group. When reacting organic acids with metals, in order for the finished metal-organic-acid compound to remain soluble, there must be an overall charge for the compound to remain in solution. When L-aspartic acid is reacted with a metal oxide, as the reaction progresses, the pH may gradually rise which can result in deprotonating the alpha group, allowing it coordinate with the metal. Where the L-aspartic acid to amino acid ration is 2:1 in the solution, there are two alpha carboxyl groups that can coordinate with each metal. As the pH continues to increase, and rises past 3.86, the side groups deprotonate and can remain negatively charged, and uncoordinated with the metal. This group can further be reacted with ethanolamine or other suitable compounds including but not limited diethanolamine, triethanolamine, L-arginine, and L-lysine to further increase the total charge of the compound by introducing an amine group to each carboxyl side group, and to depress the freezing temperature of the solution.

A covalent bond can be formed between each amine group of L-aspartic acid or other suitable amino acid, and the final diaspartate metal chelate can be a x-hydrate diaqua tetradendate ligand having the following formula: [metal(C₄H₅NO₄)₂.x(H₂O)] with an overall negative charge of −2 from the non-coordinated beta carboxyl groups (that form an ionic bond with the cationic amine groups of ethanolamine). In some exemplary embodiments, x can equal at least two water molecules, but may include more depending upon the reaction temperature. This micronutrient composition can allow for the metal to be protected and prevents its interaction with other molecules that may be present in a reservoir or spray tank that would otherwise react with metal and form insoluble precipitates that may decrease the efficacy of the metal and the other molecule or additive (e.g., pesticide, herbicide, etc.). In some exemplary embodiments, the micronutrient composition can utilize with a d-block period 4 transition metals of manganese, iron, cobalt, nickel, copper, and zinc. Additionally, the composition and method can be utilized to form soluble complexes with the divalent alkaline earth metals of magnesium and calcium.

In some embodiments, stability constants can be formed by a diaspartate chelate structure may not be high enough to prevent interaction and precipitation with certain molecules. In such a case the micronutrient composition can include an additional component, including but not limited to a carboxylated polymer salt can be added to the diaspartate metal chelate solution. In one exemplary embodiment, polyaspartate can be formed from L-aspartic acid monomers. Polyaspartate anionic polymer salts can function as scale inhibitors, and prevent the interaction of positively charged metals with negatively charged elements, such as phosphorus. Polyaspartate salts can inhibit calcium and magnesium from forming insoluble salts with phosphates and sulfates. Many waters in agricultural settings have high amounts of calcium and magnesium ions in the water. Some pesticides, like glyphosate, are acids that have been reacted with bases to form soluble salts that greatly increase the solubility and efficacy of the pesticide. Glyphosate is usually found as a potassium, isopropylamine, or ammonium salt. When calcium and/or magnesium are in the water, the calcium and magnesium can displace the monovalent cations, and can react with the glyphosate molecule forming calcium glyphosate or magnesium glyphosate thus greatly reducing the solubility of glyphosate and dramatically decreasing its efficacy.

In some exemplary embodiments, ammonium sulfate can be added in a tank first so that the calcium and magnesium displace the ammonium ion and form calcium sulfate and magnesium sulfate, however, the calcium sulfate can be relatively insoluble, and can cause precipitates to form in the spray tank. Calcium sulfate may also leave the ammonium ion in the spray tank, which when applied to crops during hot and dry conditions could cause phytotoxicity and stress to the plant. This is because ammonium is deprotonated to ammonia in the cells of the plants. This ammonia must be fixed into an organic (carbon-containing) compound as quickly as possible as ammonia is toxic to plant cells. In the case of foliar applications with low volumes of water, the ammonium concentration can be quite high, and lead to a rapid, and potentially detrimental, level of ammonium in the plant cells. The polyaspartate polymer salt in exemplary embodiments of a nutritional composition of the present disclosure can obviate the need to add ammonium sulfate as it would adsorb the calcium and magnesium ions in solution and prevent them from reacting with the pesticides or other additives.

Polyaspartate salts can be humectants, and as such act as an adjuvant in spray solutions. Humectants can retain or preserve moisture. By retaining or preserving moisture on the leaf surface, there is an increased opportunity for the active ingredient (metal and/or pesticide) to enter the leaf as the metal and pesticide must be in the spray solution to enter the plant. Given the low rates of spray solution used in agricultural settings (about 10 gallons per acre total solution for ground applications is typical, with rates as low as about 2 gallons per acre for aerial applications), allowing the solution to remain on the leaf longer without drying can be highly advantageous and increase the efficacy of the pesticides and metals that are applied. Research has shown an increase in crop yields stemming from a foliar application of polyaspartate salts along with a nutrient and/or a pesticide. While the diaspartate metal salts are small enough to enter the plant, the polyaspartate polymer salt (with an average molecular weight of 3,000-5,000 g/mol) does not enter the plant, and remains on the leaves, where it will eventually be washed off into the soil after a rain or irrigation event.

Most micronutrient products are formulated to solve the problem of precipitation and interaction of the micronutrient in the spray tank with little thought given the downstream metabolic implications to the plant itself. Synthetic chelates such as IDS, EDTA, DTPA, and EDDHA chelate metals very well, and form very high stability constants. When these are reacted with potassium and/or sodium (typically, but could be other bases), there's an overall charge of the chelate compound, and the metal-chelate compounds are highly water soluble. The issue, however, is that all of these structures are man-made, and therefore xenobiotic (foreign) substances to the plant. There has been very little research published about how these materials affect the movement of the metal throughout the plant, or how these structures are metabolized in plants and is possible that these substances can have a negative impact on the plant's overall health as the plant has to deal with the xenobiotic substance and spend energy in sequestering and recycling it. These synthetic chelates can result in the form of phytotoxicity to the plant and “burning” of the foliage. Other chelates that might be natural, like citric acid, have other issues—not chelating the metal strongly enough, not being soluble enough, or producing a finished product with a pH that is too low, the latter causing issues with the emulsifiers in pesticidal products, causing the separation of the formulation in the spray tank. In addition to this, given the concentration of citric acid in plants, the positive metabolic effects are minimal.

L-aspartic acid monomer has important metabolic functions in plants and additionally can function as an excellent chelate for metals. When inorganic nitrogen like nitrate and ammonium are applied to plants must fix that nitrogen into an organic form as quickly as possible. Nitrate and ammonium levels that build up can be toxic to plant cells. Aspartic acid is one of first amino acids formed during nitrogen fixation process. Additionally, the aspartate aminotransferase enzyme can convert aspartic acid into glutamic acid, where it can be used as the starting material for chlorophyll; or when it can be further converted into gamma-aminobutyric acid which can balance the pH of the cytosol, scavenge oxygen-free radicals, and can reduce the stress of the plant by acting as an osmolyte whereby it can help cells retain water even during low water and high salt conditions. L-aspartic acid can also convert to L-lysine, L-methionine, L-threonine, and L-isoleucine which are all essential amino acids for the plants and play important roles in crop production and yield. In corn (Zea mays), a C4 plant, carbon dioxide is fixed in the form L-aspartic acid where it is transported from the mesophyll cells into the bundle sheath cells where it can be used by the plant. Finally, the L-aspartic acid can assist in the production of adenosine monophosphate (AMP), which eventually turns into adenosine triphosphate (ATP), also known as the energy currency of cells.

The present disclosure provides that the reaction of L-aspartic acid with metal salts a polyaspartate salt addition yields a stability and compatibility-enhancing composition that is effective at preventing micronutrients from reacting with phosphate-based pesticides and other pesticides that may ordinarily have compatibility issues with non-chelated metals. In some exemplary embodiments, the optimal molar ratio of aspartic acid to metal is about 2:1.

The disclosed micronutrient compositions may be used in any or may include a variety of micronutrients in the form of metal ions including hexaaqua ions, oxide, hydroxide, and carbonate salts. This list could include, but is not limited to calcium oxide, calcium hydroxide, calcium carbonate, magnesium oxide, magnesium hydroxide, magnesium carbonate, hexaaqua cobalt, cobalt oxide, cobalt hydroxide, colbalt carbonate, hexaaqua copper, copper (II) oxide, copper (II) hydroxide, copper (II) carbonate, hexaaqua iron, iron (III) oxide, iron (II, III) oxide, iron (II) hydroxide, iron (III) hydroxide, iron (II) carbonate, hexaaqua manganese, manganese (II) oxide, manganese (II) hydroxide, manganese (II) carbonate, hexaaqua nickel, nickel (II) oxide, nickel (II) hydroxide, nickel (II) carbonate, hexaaqua zinc, zinc oxide, zinc hydroxide, and zinc carbonate. The preferred metal salts vary from nutrient to nutrient. For the alkaline earth metals, calcium hydroxide and magnesium hydroxide are preferred. For the transition metals, the preferred embodiments can include: cobalt carbonate, copper hydroxide, iron (III) oxide (or iron (II, III) oxide), manganous oxide, nickel carbonate, and zinc oxide.

The types of carboxylated polymer salts may be, but are not limited to: amine-containing polymers such as sodium polyaspartate, potassium polyaspartate, ammonium polyasparate, ethanolamine polyaspartate, L-argininium polyasparate, L-lysinium polyaspartate, polyglutamic acid salts, and copolymers thereof, and carboxylated polymers not containing amino groups such as polyepoxysuccinic acid salts, polymaleic acid salts, polyitaconic acid salts, and copolymers and combinations thereof with a molecular weight ranging from 1000 grams per mol to 10,000 grams per mol with an optimal size ranging from 3000 to 6000 grams per mol.

A number of additional additives/solutions, which may include but are not limited to pesticides, herbicides, insecticides, acaricides, bactericides, and/or fungicides can be compatible with the micronutrient compositions of the present disclosure. The micronutrient composition can be mixed with one or more additives at any suitable ration for efficacy of both the micronutrient composition and the additive. In some exemplary embodiments, the micronutrient composition to additive ration can be between about 10:1 and 1:10 ratio (micronutrient:additive), or between about 5:1 and 1:5, or between about 2:1 and 1:2, or about a 1:1 ratio (micronutrient:additive). It could be a 2:1 ratio (herbicide:micronutrient).

Herbicides may include but are not limited to: N-(phosphonomethyl)glycine, e.g., glyphosate, in various forms including in the form of a salt, ester, or other derivative thereof. Examples include, but are not limited to: its form as a potassium salt (e.g., Roundup® PowerMax® and Touchdown Total® , as a dimethylamine salt (e.g., Durango DMA), in its form as an isopropylamine salt (e.g., Cornerstone 5+), and glyphosate in combination with other pesticides such as 2,4-Dichlorophenoxyacetic acid (2,4-D) (e.g. Enlist Duo) and with dicamba (e.g. RoundUp® Xtend®).

Other compatible herbicides may include, but are not limited to: the sodium salt of bentazon (3-(1-methylethyl)-1H-2,1,3-benzothiadiazin-4 (3H)-one 2,2-dioxide) (e.g. Basagran), diglycolamine salt of 3,5-dichloro-o-anisic acid (e.g. Sterling Blue); 3,6-dichloro-2-methybenzoic acid (e.g. Dicamba, Enginia); 2-4-Dichlorophenoxyacetic acid (2,4-D); 1-chloro-3-ethylamino-5-isopropylamino-2,4,6-triazine (Atrazine); amide herbicides; arsenical herbicides; carbamate and thiocarbamate herbicides; carboxylic acid herbicides; dinitroaniline herbicides; heterocyclic nitrogen-containing herbicides; organophosphate compounds; urea herbicides; and quaternary herbicides; 5-[2-chloro-4-(trifluoromethyl)phenoxy]-N-(methylsulfonyl)-2-nitrobenzamide (Fomesafen); and temobtrione (e.g. Laudis).

In addition to herbicides, fungicides may be used in agricultural sprays. Compatible fungicides and bactericides include, but are not limited to: Nucleic acid synthesis inhibitors (e.g. benalaxyl, furalaxyl, metalaxyl, ofurace, oxadixyl, buprimate, dimethrimol, ethirimol, hymexazole, octhilinone, oxolinic acid), fungicides that affect mitosis and cell division (e.g. benomyl, carbendazim, fuberidazole, thiabendazole, thiophanate, thiophanate-methyl, diethofencarb, zoxamide, pencycuron, fluopicolide); fungicides that generally affect respiration (penfluefen, furametpyr, penthiopyrad, bixafen, isopyrazam, sedaxane, fluxapyroxad, thifluzamide, boscalid, oxycarboxin, carboxin, fluopyram, fenfuram, flutolanil, mepronil, benodanil); fungicides that specifically inhibition the complex III cytochrome bc1 at Qo site (also known as Quinone outside Inhibitors) (azoxystrobin—e.g. Priaxor, On Set, Topaz, Headline amp, Headline SC, Stratego, Quadris—picoxystrobin, enoxastrobin, pyraoxystrobin, cuomoxystrobin, flufenoxystrobin, orysastrobin, dimoxystrobin, metominostrobin, fenaminostrobin, pyraclostrobin, pyrametrostrobin, triclopyricarb, kresoxim-methyl, trifloxystrobin, famaoxadone, fenamidone, pyribencarb, fluoxastrobin, silthiofam, fentin acetate, fentin chloride, fentin hydroxide, fluazinam, ferimzone, meptyl dinocap, binapacryl); fungicides and bactericides that inhibitor amino acid and protein synthesis (cyprodinil, mepanipyrim, pyrimethanil, blasticidin-S, streptomycin, kasugamycin, oxytetracycline) fungicides that inhibit signal transduction (quinoxyfen, proquinazid, fenpiclonil, fludioxonil, chlorolinate, procymidone, iprodione, vinclozolin); fungicides that inhibit lipid and membrane synthesis (pyrazophos, iprobenfos, edifenphos, isoprothiolane, dicloran, tecnazene, tolclofos-methyl, biphenyl, chloroneb, etridiazole, propamocarb, iodocarb, prothiocarb, Bacillus subtilis Strain QST 713); fungicides that inhibit sterol biosynthesis in membranes (triazoles—e.g. tebuconazole, metconazole, myclobutanil, propiconazole—piperazines, pyridines, pyrimidines, imidazoles, morpholines, piperidines, spiroketalamines, fenhexamid, allylamines, thiocarbamates); fungicides that inhibit cell wall biosynthesis (validamycin, polyoxin B, dimethomorph, flumorph, mandipropamid, iprovalicarb, benthivalicarb, valifenalate); fungicides that inhibit melanin synthesis in cell walls (fthalide, pyroquilon, tricyclazole, carpropamid, diclocymet, fenoxanil); fungicides that induce host defenses (acibenzolar-S-methyl, probenazole, isotianil, tiadnil, laminarin); fungicides with unknown modes of action (cymoxanil, fosetyl-al, phosphorous acid, teclofthalam, ethaboxam, cyflufenamid, flutianil, triazoxide, flusulfamide, diclomezine, methasulfoxarb, #12 dodine, #U8 metrafenone, #8 pyriofenone); fungicides with multi-site action (copper, sulfur, ferbam, mancozeb, metiram, thiram, propineb, maneb, ziram, zineb, anilazine, dithianon, chlorothalonil, captan, captafol, folpet, dichlorofluanid, tolyfluanid, guazatine, iminoctadine)

In addition to fungicides and bactericides, insecticides and acaricides may be used in agricultural sprays. Compatible insecticides and acaricides include, but are not limited to: acetylcholinesterase inhibitors (aldicarb, benfuracarb, carbaryl, carbofuran, carbosulfan, fenobucarb, methiocarb, methomyl, oxyamyl, thiodicarb, triazamate, acephate, chlorpyrifos, dimethoate, diazinon, malathion, methamidophos, monocrotophos, parathion-methyl, profenofos, terbufos); GABA-gated chloride channel antagonists (chlordane, endosulfan, ethiprole, fipronil); sodium channel modulators (bifenthrin, cyfluthrin, cypermethrin, alpha-cypermethrin, zeta-cypermethrin, deltamethrin, esfenvaleterate, etofenprox, lamba-cyhalothrin, tefluthrin, pyrethrins, methoxychlor); nicotinic acetylcholine receptor agonists (acetamiprid, clothianidin, dinotefuran, imidacloprid, nitenpyram, thiamethoxam, nicotine, sulfoxaflor); nicotinic acetylcholine receptor allosteric modulators (spinetoram, spinosad); chloride channel activators (emamectin benzoate, abamectin, milbemectin, lepimectin); juvenile hormone mimics (kinoprene, fenoxycarb, pyriproxyfen); miscellaneous non-specific (multi-site) inhibitors (methyl bromide, chloropicrin, sulfuryl fluoride, borax, tartar emetic); selective homopteran feeding blockers (pymetrizone, flonicamid); mite growth inhibitors (clofentezine, hexythiazox, etoxazole); microbial disruptors of insect midget (Bacillus thuringiensis, Bacillus sphaericus); inhibitors of mitochondrial ATP synthase (diafenthiuron, azocyclotin, cyhexatin, fenbutatin, propargite, tetradifon); uncouplers of oxidative phosphorylation via disruption of proton gradient (chlorfenapyr, DNOC, sulfluramid); nicotinic acetylcholine receptor channel blockers (bensultap, cartap hydrochloride, thiocyclam, thiosultap-sodium); inhibitors of chitin biosynthesis (bistrifluron, chlorfluazuron, diflubenzuron, flucycloxuron, flufenoxuron, hexafluxmuron, lufenuron, novaluron, noviflumuron, teflubenzuron, triflumuron); inhibitors of chitin biosynthesis type 1 (buprofezin); moulting disruptor for dipterans (cyromazine); ecdysone receptor agonists (chromafenozide, halofenozide, methoxyfenozide, tebufenozide); octopamine receptor agonists (amitraz); mitochondrial complex III electron transport inhibitors (hydramethylnon, acequinocyl, fluacrypyrim); mitochondrial complex I electron transport inhibitors (fenzaquin, fenpyroximate, pyridaben, pyrimidifen, tebufenpyrad, tolfenpyrad, rotenone); voltage-dependent sodium channel blockers (indoxacarb, metaflumizone); inhibitors of acetyl CoA carboxylase (spirodiclofen, spiromesifen, spirotetramat); mitochondrial complex IV electron transport inhibitors (aluminum phosphide, calcium phosphide, zinc phosphide, phosphine, cyanide); mitochondrial complex II electron transport inhibitors (cyenopyrafen, cyflumetofen); ryanodine receptor modulators (chlorantraniliprole, cyantraniliprole, flubendiamde); compounds of unknown or uncertain mode of action (azadiracthrin, bifenazate, cyrolite, pyridalyl, benzoximate, chinomethionat, dicofol, pyrifluquiazon).

The compositions of the present invention can be applied to plants or foliar surfaces of a plant in an environment. The solution can be applied using any suitable method such as a sprayer and applied to the foliar surface or the ground surrounding the plants to be treated. In some exemplary embodiments, the compositions can include a carboxylated polymer (between about 2.5-15% by weight), at least one metal (between about 4-12% by weight), and an aspartic acid (between about 18-44% by weight). In other exemplary embodiments, alternative any other suitable amino acid can be used in place of aspartic acid, including but not limited to glutamic acid, proline, glutamine, or asparagine. In some exemplary embodiments, the carboxylated polymer can be present in a in the composition at between at 5% by weight.

A composition of the present disclosure can further include a pesticide or other additive. In some exemplary embodiments, after the initial reaction with aspartic acid and a metal, ethanolamine can be mixed with the metal-aspartic acid chelate at a ratio between about 2:1 to 1:2, or in an about 1:1 molar ratio. The final composition can have a pH between about 4-10 or between about 7-10. In some exemplary embodiments, a composition can then be applied to an environment such as turf, ground or the foliar surface of a plant and any suitable treatment amount. In some exemplary embodiments, the micronutrient/additive solution can be applied at any suitable amount to the environment. In some exemplary embodiments, the application can be applied at an amount between about 8 oz to 128 oz per acre or between about 24 oz to about 64 oz per acre or at about 32 oz acre. The admixture can be further diluted with a water solution at any suitable ratio.

### EXAMPLES AND EXPERIMENTAL DATA

### Example 1: Forming a Manganese Diaspartate with Potassium Polyaspartate Micronutrient Composition

In an about 1000 mL glass beaker can be filled with between about 223 and 225 grams of reverse-osmosis (RO) water and between about 180 and 182 grams of L-aspartic acid and placed on a hot plate. The hot plate can be set to a temperature of about 285° C. The sample was stirred via overhead agitation at a constant rate of about 500 rpm throughout the mix. Once the water/L-aspartic acid mixture reached about 60° C., between about 46 and 48 grams of manganous oxide can be added. Heat can be continuously added in order to reach a temperature of 80° C. whereby the mixture was allowed to mix for an additional 3 hours with RO water continuous added to account for the loss of water from the beaker.

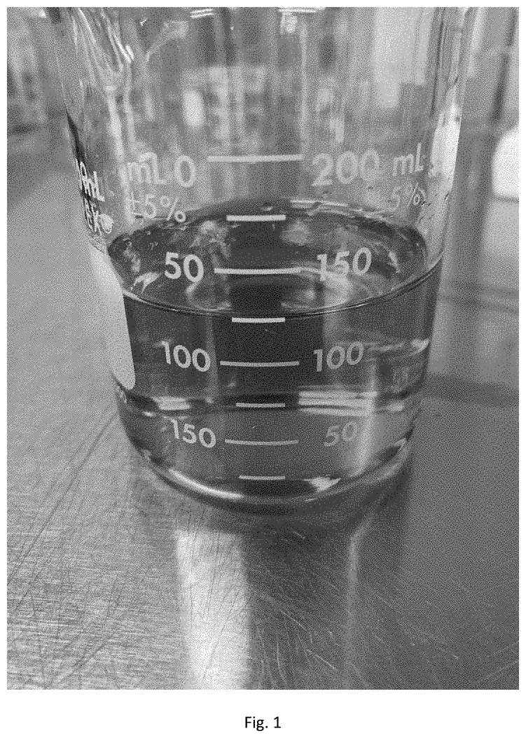

After about 3 hours, the 500-mL mixture was a clear, light pink solution comprising an aqueous solution of manganese diaspartate. To this mixture, between about 82 and 84 grams of monoethanolamine (MEA) can be added and allowed to react and mix for 20 minutes. Once the mixture was fully reacted, between about 62 and 64 grams of a 47.5% potassium polyaspartate solution was added and mixed for an additional 10 minutes. The solution was 6.0% by weight manganese, 29.9% by weight L-aspartic acid, and 5.0% by weight potassium polyaspartate, and had a finished pH of 9.3. With both L-aspartic acid carboxyl groups deprotonated above a pH of 3.86, the manganese +2 ion was covalently bonded by the alpha carboxyl group of each L-aspartic acid molecule and the amine group of each aspartic acid, creating a soluble, stable tetradentate ligand. The carboxyl side group of L-aspartic acid formed an ionic bond with the amine group of ethanolamine that is admixed with a potassium polyaspartate polymer. The finished solution is stable in temperature ranges of between about −10° C. to 55° C. and was stable at room temperature for over 12 months as shown in FIG. 1.

### Example 2: Forming a Zinc Diaspartate with Potassium Polyaspartate Micronutrient Composition

A 1000-mL glass beaker can be filled with between about 189 and 193 grams of reverse-osmosis (RO) water and between about 208 and 210 grams of L-aspartic acid and placed on a hot plate. The hot plate can be set to a temperature of about 205° C. The sample can be stirred via overhead agitation at a constant rate of about 500 rpm throughout the mix. Once the water/L-aspartic acid mixture reached 38° C., between about 62 and 64 grams of zinc oxide can be added. The mixture can be exothermic, and with the help of additional heat from the hot plate, the mixture can reach a temperature of about 60° C. where it was allowed to mix for about 20 minutes.

After about 20 minutes, the L-aspartic acid and zinc oxide can react with the solution having a pH below 3.86, leaving the beta carboxyl group of each aspartic acid uncharged. To address this issue, between about 94 and 96 grams of monoethanolamine (MEA) can be slowly added to the solution, raising the temperature to about 72 degrees C. and raising the finished pH to about 8.1, creating an ionic bond between MEA and the beta carboxyl group of each L-aspartic acid.

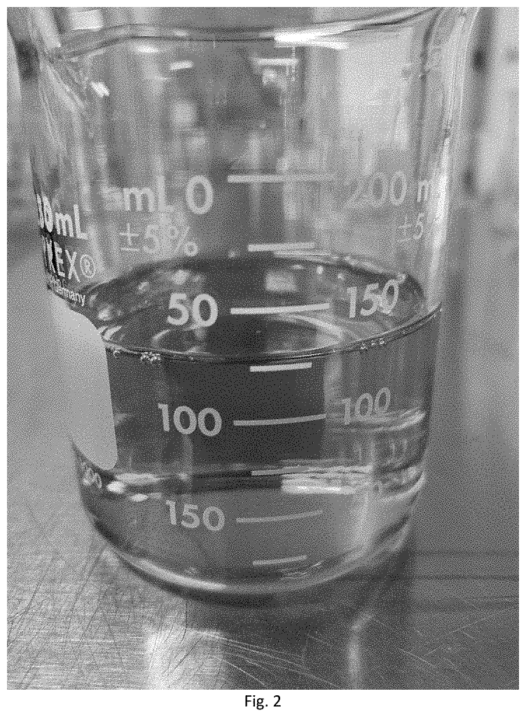

After allowing the mixture to mix for about 1 hour, the solution is a clear, light-yellow solution comprising an aqueous solution of zinc diaspartate with an ionic bond to MEA. To this, between about 65 and 67 grams of a 47.5% potassium polyaspartate solution can be added and allowed to mix for about an additional 10 minutes. The solution was 8.0% by weight zinc, 37.3% by weight aspartic acid, and 5.0% by weight potassium polyaspartate and had a finished pH of 8.2. At a pH of 8.2, the zinc +2 ion was covalently bonded by the alpha carboxyl group of each L-aspartic acid molecule, and the amine group of each aspartic acid. The beta carboxyl group of each L-aspartic acid molecule formed an ionic bond with each MEA molecule, creating a soluble, stable tetradentate ligand. The finished solution is stable in temperature ranges of about −15° C. to 55° C., and was stable at room temperature for over 12 months as shown in FIG. 2.

### Example 3: Forming a Micronutrient Admixture with Polyaspartate Micronutrient Composition

A 1000-mL glass beaker was filled with about 4.51 grams of reverse-osmosis (RO) water and about 63.32 grams of 47.5% potassium polyaspartate solution. The sample can then be stirred via overhead agitation at a constant rate of 500 rpm throughout the mix at room temperature. Following this, about 0.78 grams of sodium molybdate can be added, along with between about 299 and 301 grams of manganese diaspartate solution containing 6.0% manganese by weight, between about 200 and 202 grams of zinc diaspartate solution containing about 9.0% zinc by weight, and between about 29-31 grams of a 10% boron solution formed by reacting boric acid with monoethanolamine.

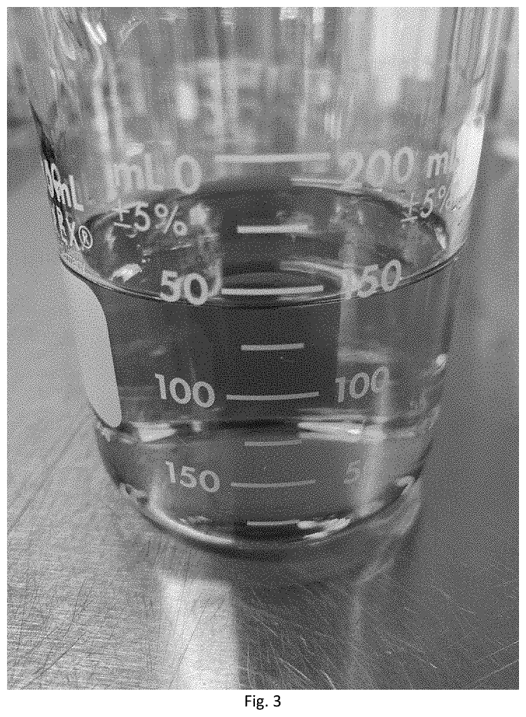

After mixing for 20 minutes, the solution was a clear amber color that had a finished pH of 9.0. The mixture was about 0.05% by weight molybdenum, about 0.5% by weight boron, about 3.0% by weight manganese, about 3.0% by weight zinc, and about 5.0% by weight potassium polyaspartate. The finished solution is stable in temperature ranges of −10° C. to 55° C., and was stable at room temperature for over 12 months as shown in FIG. 3

### Example 4: Forming the Agricultural Spray Admixture Including a Micronutrient Composition and an Additional Additive

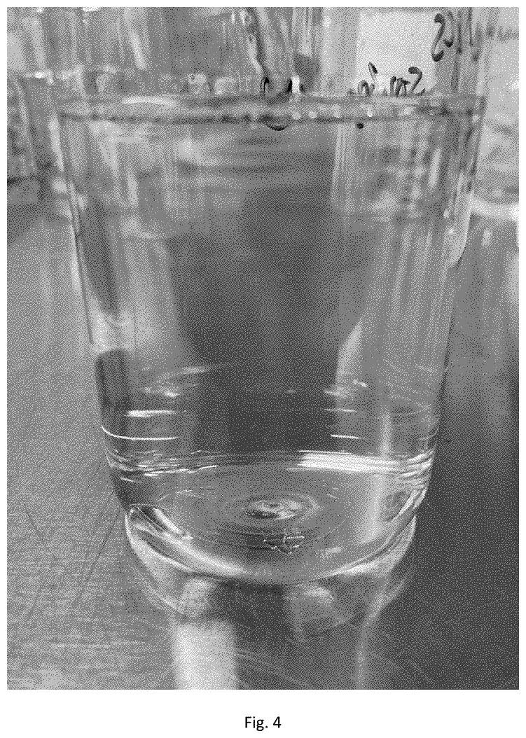

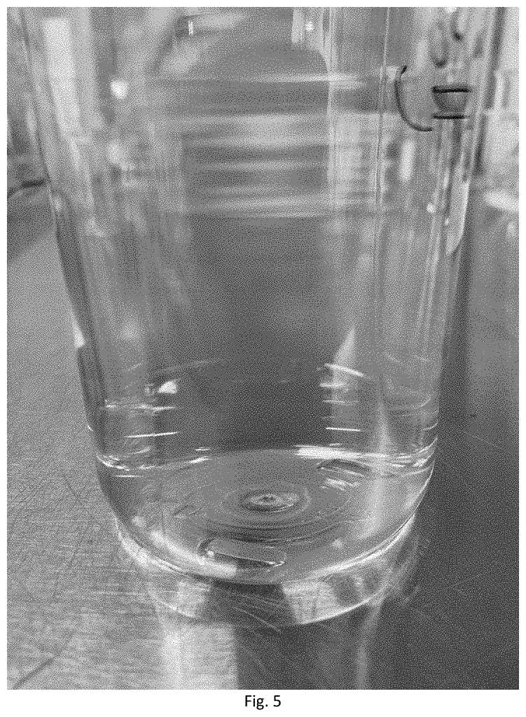

In a 1000 mL beaker was filled with about 436.60 grams of reverse-osmosis (RO) water and stirred at a constant rate of about 500 rpm via overhead agitation. About 24.20 grams of Roundup® PowerMAX® (48.7% Glyphosate, N-(phosphonomethyl)glycine, in the form of a potassium salt) was added to the water and allowed to enter into the solution. Following this, about 24.20 grams of the finished micronutrient/polyaspartate admixture from example 3 can be added and formed a clear solution. After the solution is mixed for about an additional 5 minutes, the finished micronutrient/polyaspartate/glyphosate admixture was bottled off and observed daily over a period of 14 days. The solution remained clear without any separation, gelling, precipitation, agglomeration, or flocculation as shown in FIG. 4. Similarly, the micronutrient composition of Example 3 can be mixed with dicamba and after 14 days at an equivalent rate of 4 ounces of each product in 10 gallons of water remained clear without any separation, gelling, precipitation, agglomeration, or flocculation as shown in FIG. 5.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A method of treating a foliar surface with an agricultural spray, comprising:
admixing an admixture composition comprising aspartic acid and ethanolamine at a 1:1 ratio with the aspartic acid with a metal oxide, a carboxylated polymer salt, and a pesticide, wherein the pesticide comprises a phosphate component, wherein the aspartic acid chelates the metal oxide and the carboxylated polymer salt to prevent the metal oxide from forming an insoluble solid with the phosphate, wherein the aspartic acid is present in a molar ratio of 2:1 aspartic acid to metal oxide, wherein the agricultural spray remains stable and non-precipitated for at least 72 hours when combined in a vessel containing water to form the agricultural spray solution; and
applying to the foliar surface the agricultural spray solution composition.

2. The method of claim 1, wherein the aspartic acid is present with the metal oxide at a molar ratio of 2:1.

3. The method of claim 1, wherein the carboxylated polymer salt is potassium polyaspartate polymer and molecular weight of the potassium polyaspartate polymer is between 3000 to 5000 grams per mol.

4. The method of claim 3, wherein the carboxylated polymer salt is present in the admixture composition between 2.5-15% by weight.

5. The method of claim 2, wherein the metal oxide has a metal component is present at a between 4-12% by weight of one or more of the following: calcium, magnesium, cobalt, copper, iron, manganese, nickel, and zinc.

6. The method of claim 2, wherein the metal oxide is at least one of the following:
calcium hydroxide, magnesium hydroxide, cobalt carbonate, copper hydroxide, ferric oxide, manganous oxide, nickel carbonate, or zinc oxide.

7. The method of claim 1, wherein the pesticide comprises N-(phosphonomethyl)glycine.

8. The method of claim 1, wherein the N-(phosphonomethyl)glycine is one or more of a salt, an ester, or a derivative of the salt or the ester.

9. A method of producing an enhanced agricultural spray composition comprising:
reacting of aspartic acid and ethanolamine at a 1:1 molar ration to form an aspartic acid solution; and
reacting the aspartic acid solution with a metal oxide in a 2:1 aspartic acid solution to metal oxide ratio in an aqueous solution with an admixture of a polyaspartate salt, wherein the composition remains stable, non-precipitated for over one year, wherein the aspartic acid is present in the admixture composition between 18-44% by weight.

10. The method of claim 16, wherein the chelated composition comprises at least the pesticide, the pesticide including at least one of the following: N-(phosphonomethyl)glycine, 4-Dichlorophenoxyacetic acid, bentazon, 3,5-dichloro-o-anisic acid, 3,6-dichloro-2-methoxybenzoic acid, 1-chloro-3-ethylamino-5-isopropylaminoe-2,4,6-triazine, amide herbicides, arsenical herbicides, carbamate and thiocarbamate herbicides, carboxylic acid herbicides, dinitroaniline herbicides, heterocyclic nitrogen-containing herbicides, organophosphate compounds, urea herbicides, and quaternary herbicides, 5-[2-chloro-4-(trifluoromethyl)phenoxy]-N-(methylsulfonyl)-2-nitrobenzamide, tembotrione or a salt of an ester of the pesticide.

11. A micronutrient composition for enhancing micronutrient uptake in plants comprising:
a metal salt component comprising between 4-12% by weight of the composition;
an aspartic acid component comprising between 18-44% by weight of the composition; and
a carboxylated polymer component comprising between 2.5-15% by weight of the composition.

12. The composition of claim 11, further comprising a pesticide component.

13. The composition of claim 11, wherein the aspartic acid component is first admixed with ethanolamine at a 1:1 ratio.

14. The composition of claim 13, wherein the aspartic acid component to metal salt component molar ratio is 2:1.

15. The composition of claim 14, wherein the pH is between 7 and 10.

16. The composition of claim 15, wherein the aspartic acid component is L-aspartic acid.

17. The composition of claim 16, wherein the metal salt component is a x-hydrate diaqua tetradendate ligand having the following formula: [metal(C₄H₅NO₄)₂.x(H₂O)] with an overall negative charge of −2 from the non-coordinated beta carboxyl groups that form an ionic bond with the cationic amine groups of ethanolamine.

18. The composition of claim 16, wherein the metal salt component is at least one of the following:
calcium hydroxide, magnesium hydroxide, cobalt carbonate, copper hydroxide, ferric oxide, manganous oxide, nickel carbonate, or zinc oxide.

19. The composition of claim 12, wherein the pesticide can include one or more of the following: N-(phosphonomethyl)glycine, 4-Dichlorophenoxyacetic acid, bentazon, 3,5-dichloro-o-anisic acid, 3,6-dichloro-2-methoxybenzoic acid, 1-chloro-3-ethylamino-5-isopropylaminoe-2,4,6-triazine, amide herbicides, arsenical herbicides, carbamate and thiocarbamate herbicides, carboxylic acid herbicides, dinitroaniline herbicides, heterocyclic nitrogen-containing herbicides, organophosphate compounds, urea herbicides, and quaternary herbicides, 5-[-2-chloro-4-(trifluoromethyl)phenoxy]-N-(methylsulfonyl)-2-nitrobenzamide, tembotrione or a salt of an ester of the pesticide.

20. A solution for treating an environment comprising:
a micronutrient composition comprising:
a metal salt component comprising between 4-12% by weight of the micronutrient composition;
an amino acid component comprising between 18-44% by weight of the micronutrient composition wherein the amino acid component is combined with ethanolamine at a 1:1 ratio, wherein the amino acid component is present in a molar ratio of 2:1 with respect to the metal salt component;
a carboxylated polymer component comprising between 2.5-15% by weight of the micronutrient composition, wherein the amino acid component chelates the metal salt component and along with the carboxylated polymer component prevents the metal salt component from forming an insoluble solid; and
a pesticide.
